(19) United States
(12) Patent Application Publication
(10) Pub. No.: US 2014/0231161 A1
(43) Pub. Date: Aug. 21, 2014

(54) ACTIVE HOOD EXTRACTOR

(71) Applicant: GM GLOBAL TECHNOLOGY OPERATIONS LLC, Detroit, MI (US)

(72) Inventors: Michael Lehti, Ashburn (CA); Mark D. Dickens, Ortonville, MI (US)

(73) Assignee: GM Global Technology Operations LLC, Detroit, MI (US)

(21) Appl. No.: 13/768,301

(22) Filed: Feb. 15, 2013

(51) Int. Cl. B62D 25/12

(52) U.S. Cl. CPC B62D 25/12
USPC 180/68.1

(57) ABSTRACT

A number of variations may include a product comprising: an active hood extractor including a plurality of louvers, and actuator operatively connected to at least one louver, the plurality of louvers being constructed and arranged for sealing engagement with another vehicle component. A number of variations may include a product comprising: an active hood extractor including a plurality of louvers, the plurality of louvers being constructed and arranged for sealing engagement with another vehicle component when the plurality of louvers are in a closed position.

### TECHNICAL FIELD

The field to which the disclosure generally relates to includes hood extractors for vehicles.

### BACKGROUND

Vehicles may be equipped with louvers positioned in the engine compartment hood or may include nonfunctional ornamental louvers.

### SUMMARY OF ILLUSTRATIVE VARIATIONS OF THE INVENTION

A number of variations may include a product comprising: an active hood extractor including a plurality of louvers, and actuator operatively connected to at least one louver, the plurality of louvers being constructed and arranged for sealing engagement with another vehicle component when the plurality of louvers are in a closed position.

A number of variations may include a product comprising: an active hood extractor including a plurality of louvers, the plurality of louvers being constructed and arranged for sealing engagement with another vehicle component when the plurality of louvers are in a closed position.

Other illustrative variations of the invention will become apparent from the detailed description provided hereinafter. It should be understood that the detailed description and specific examples, while disclosing optional variations of the invention, are intended for purposes of illustration only and are not intended to limit the scope of the invention.

### BRIEF DESCRIPTION OF THE DRAWINGS

Select examples of variations of the invention will become more fully understood from the detailed description and the accompanying drawings, wherein:

FIG. 1 is a perspective view of a vehicle including an active hood extractor.

FIG. 2 is a side view of a product including a plurality of louvers connected together showing the louvers in a closed position and in sealing engagement according to a number of variations of the invention.

FIG. 3 is a side view of the product of FIG. 2 showing the louvers and an open position according to a number of variations of the invention.

FIG. 4 is a plan view of an active hood extractor showing louvers in a closed position and flush with a hood extractor trim component which is received and an opening of the engine compartment hood of a vehicle according to a number of variations of the invention.

FIG. 5 is a plan view of an active hood extractor showing louvers in a closed position and flush with a vehicle body panel such as an engine compartment hood according to a number of variations of the invention.

FIG. 6 is a perspective view showing a louver having front and inside lips for sealing engagement with at least one of another louver, a hood extractor trim component or a vehicle body according to a number of variations of the invention.

FIG. 7 is a side view showing a compressible material providing a seal between a side lip of the louver and a vehicle body panel according to a number of variations of the invention.

FIG. 8 is a schematic illustration of an active hood extractor control system and method of operating the active hood extractor according to a number of variations of the invention.

### DETAILED DESCRIPTION OF ILLUSTRATIVE VARIATIONS OF THE INVENTION

The following description of the variations is merely illustrative in nature and is in no way intended to limit the invention, its application, or uses.

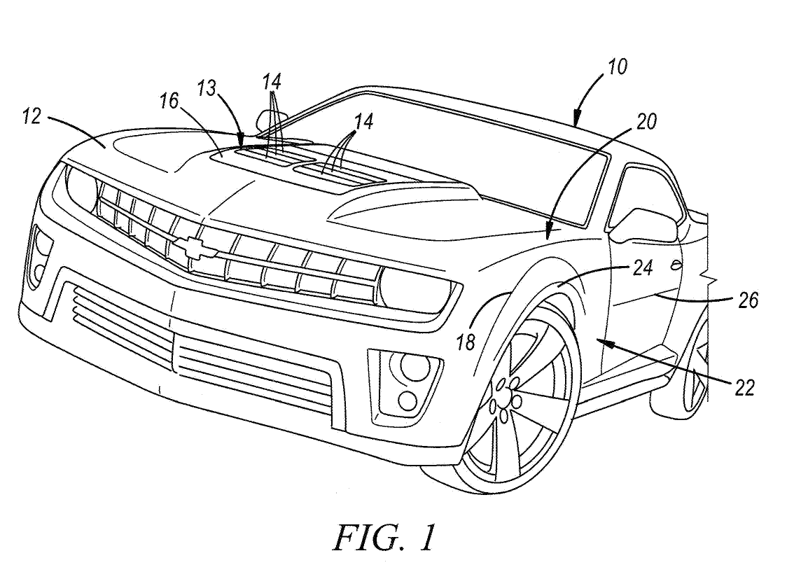

A number of variations of the invention are illustrated in FIG. 1, and may include a product, such as a vehicle 10 which may include an engine compartment hood 12 having an active hood extractor 13 including a plurality of louvers 14. In a number of variations, the louvers may be received in a hood extractor trim component 16 which is received in one of the vehicle body panels, such as the engine compartment hood 12. The active hood extractor 13 may be located in any of a number of vehicle body panels including, but not limited to one or more of the fenders 18 of the vehicle. In one variation, the louvers may be provided in an upper shoulder 20 of a fender or in a rear portion 22 of the fender at a location behind the wheel well 24 and in front of the door 26 on the driver or passenger side. In a number of variations, one or more louver sets may be provided, for example a set of louvers 14 on each side of the hood 12.

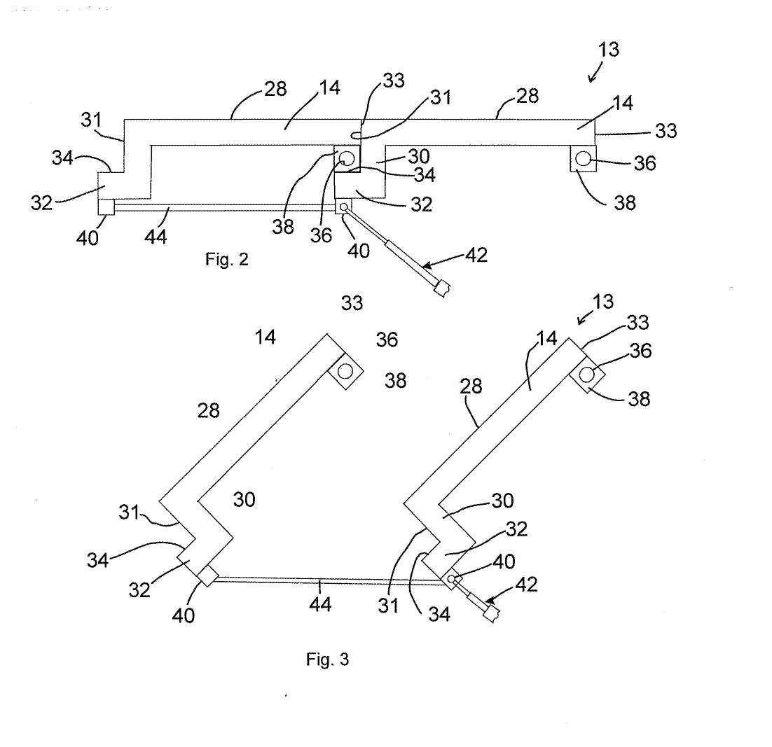

A number of variations of the invention are illustrated in FIGS. 2-3 and may include an active hood extractor 13 including a plurality of louvers 14 which may be pivotally connected by a pivot pin 36 to a hood extractor trim portion 16 or a vehicle body panel such as a hood 12 or fender 14 (shown in FIG. 1). The louvers 14 may include an exposed upper surface 28 which may be positioned to be flush with the hood extractor trim component 16 or a body panel such as the hood 12 or fender 14 of the vehicle. The louvers 14 may include a generally downwardly extending leg portion 30 connected to a front lip portion 32. The front lip portion 32 may provide a front sealing surface 34 for sealing engagement with an adjacent louver 14 or component attached thereto. in a number of variations, a compressible sealing material 38 may be provided over at least a portion of a pivot pin 36 connected to the louver 14 or over a portion of an underside of the louver 14. The front sealing surface 34 and the compressible sealing material 38 provide a watertight seal preventing water from entering through the louvers 14 when the louvers are in a closed position. In a number of variations, adjacent louvers 14 are positioned such that a front abutment face 31 of one louver abuts a portion 33 such as a first end of an adjacent louver 14. A connector portion 40 may be provided as a part of the louver 14 or an attachment thereto. A tether 44 may be provided between the connector portion 40 of adjacent louvers 14. The tether 44 may be any one of a number of materials or constructions including, but not limited to, a wire, cable, bar, arm or the like. An actuator 42 may be operatively connected to at least one of the louvers 14, for example by pivotal connection to one of the connector portions 40. The actuator 42 may be any of a variety of mechanisms including hydraulic, pneumatic, or electrical pistons, a motor such as a stepper motor, a shape memory polymer material or shape memory alloy which may be activated by any of a variety of stimulus including electricity or heat. The actuator 42 and the tether 44 work together so that when the actuator 42 moves one of the louvers 14 the tether 44 moves and adjacent louver 14.

In a number of variations, the actuator 42 may be moved to cause the plurality of louvers 14 to pivot in a downward direction as illustrated in FIG. 3. However, in a number of other variations, the louvers 14 may be constructed and arranged to pivot upward, across car, before, after or at an angle to provide openings between the louvers 14 to allow air to pass there through.

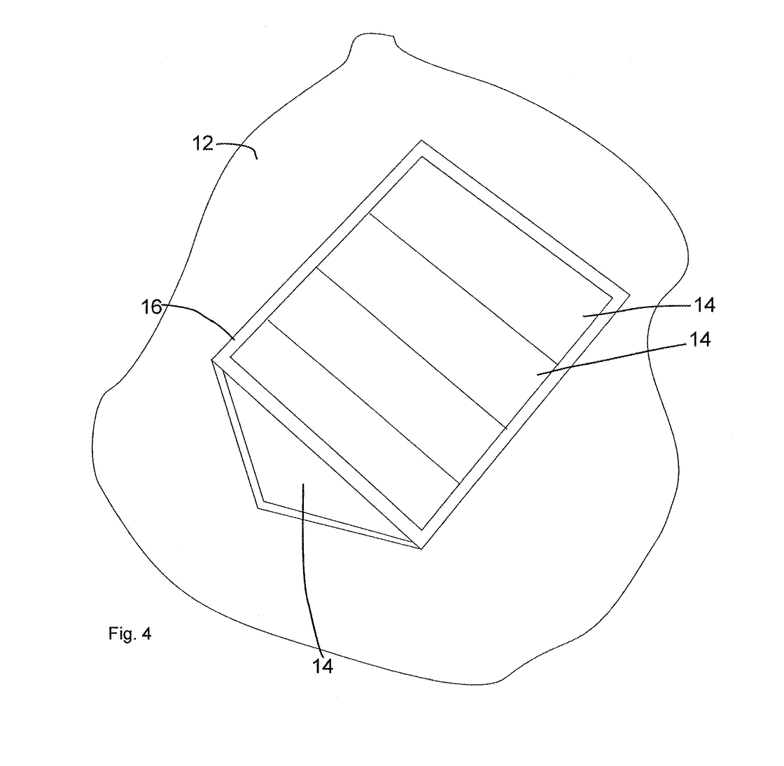

Referring now to FIG. 4, in a number of variations, the louvers 14 may be constructed and arranged to be flush with at least one of the hood extractor trim portion 16, if present, or a body panel, such as the hood 12.

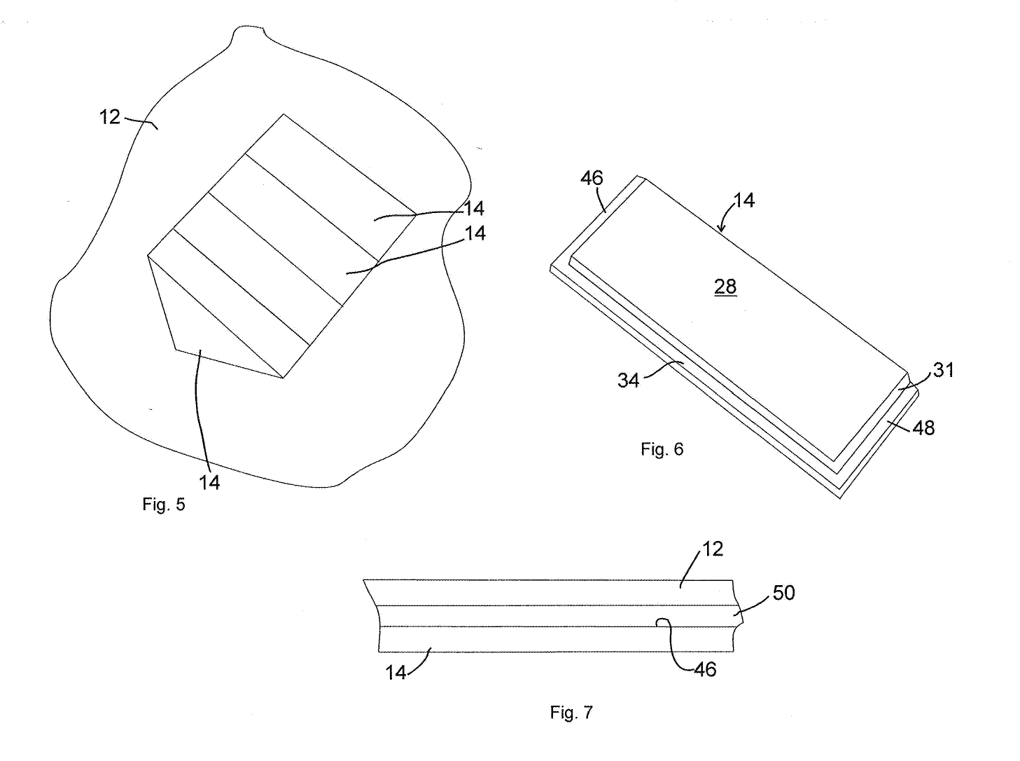

FIG. 5 illustrates a variation in which a plurality of louvers 14 are provided without an extractor hood trim component and arranged to be flush with the vehicle hood 12. The louvers may be made of a material similar to other body panel components. In one variation, the hood may include visible fibers in a clear polymeric material, such as visible woven fibers, and the louver 14 may be made of a similar or same material.

Referring now to FIG. 6, in a number of variations, a louver 14 may include an upper exposed surface 28 and may include a front sealing surface 34, a first side sealing surface 46 and a second side sealing surface 48 provided by a lip 32 extending around at least a portion of the louver 14. The sealing surfaces 34, 46 and 48 may be arranged so that the upper exposed surface 28 is flush with an adjacent body panel such as the hood 12.

Referring now to FIG. 7, a second compressible material 50 may be positioned on at least one of the sealing surfaces 34, 46 or 48 of the louver 14 or a body panel such as the hood 12, fender 18, or the hood extractor trim component 16 to provide a watertight seal. In a number of variations, the sealing engagement of the louvers 14 eliminates the need for an under hood water deflector to protect under hood components from water intrusion and from debris thereby reducing mass and cost.

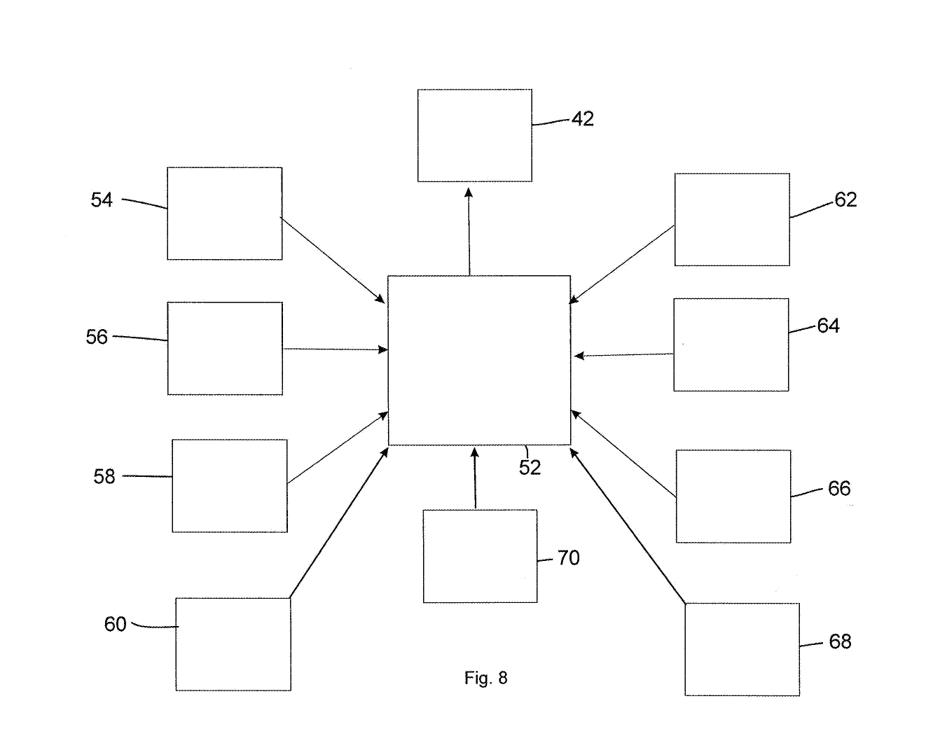

Referring now to FIG. 8, an electronic controller 52 may be provided and may be operatively connected to the actuator 52 to send signals and cause the actuator to move in one direction or another thereby causing the plurality of louvers to open, close, partially open or partially close. The controller 52 may receive input from a variety of sources including sensors and switches including, but not limited to, a vehicle speed sensor 54, engine compartment temperature sensor 56, radiator coolant temperature 58, turbocharger temperature (if a turbocharger is present) 60, air mass intake sensor 62, rain sensor 64, snow/ice sensor 66, operator switch 68 or ignition switch 70. The controller 52 may be constructed and arranged to close the louvers 14 when the vehicle is not running or when an operator selectively engages a switch to close the louvers. The controller 52 may also close the louvers when environmental conditions such as rain, snow or ice are present. The controller 52 may also control the movement of the louvers and thereby the amount of air flowing there through based upon the speed of the vehicle. The opening of the louvers allows air to travel or escape through the hood region from the under-hood compartment to the outside environment of the vehicle. The controller 52 may operate the active hood extractor 13 by opening the louvers 14 to reduce vehicle lift at high speeds, improving aerodynamics and performance of the vehicle dramatically compared to vehicles with rigid louvers that cannot adjust airflow at different vehicle speeds or prevent intrusion of water or debris when the vehicle is parked.

The following description of variants is only illustrative of components, elements, acts, product and methods considered to be within the scope of the invention and are not in any way intended to limit such scope by what is specifically disclosed or not expressly set forth. The components, elements, acts, product and methods as described herein may be combined and rearranged other than as expressly described herein and still are considered to be within the scope of the invention.

Variation 1 may include a product comprising: an active hood extractor including a plurality of louvers, and actuator operatively connected to at least one louver, the plurality of louvers being constructed and arranged for sealing engagement with another vehicle component when the plurality of louvers are in a closed position.

Variation 2 may include a product as set forth in Variation 1 wherein the active hood extractor includes a hood extractor trim component, and wherein the plurality of louvers are pivotally connected to the hood extractor trim component.

Variation 3 may include a product as set forth in any of Variations 1-2 wherein the plurality of louvers are constructed and arranged to be flush with an upper surface of the hood extractor trim component when the louvers are in a closed position.

Variation 4 may include a product as set forth in any of Variations 1-3 further comprising a tether connecting adjacent louvers.

Variation 5 may include a product as set forth in any of Variations 1-4 wherein the louvers are connected together and so that movement of the actuator moves the plurality of louvers.

Variation 6 may include a product as set forth in any of Variations 1-5 further comprising a compressible material on at least one of adjacent louvers to provide a seal when the adjacent louvers are in a closed position.

Variation 7 may include a product as set forth in any of Variations 1-6 further comprising a compressible material on at least one of the plurality of louvers or the hood extractor trim component to provide a seal when the plurality of louvers are in a closed position.

Variation 8 may include a product as set forth in any of Variations 1-7 further comprising a vehicle body panel, and a compressible material on at least one of the plurality of louvers or the vehicle body panel to provide a seal when the plurality of louvers are in a closed position.

Variation 9 may include a product as set forth in any of Variations 1-8 wherein the product comprises a vehicle and further comprising a controller constructed and arranged to cause the actuator to move in response to input regarding an operating condition of the vehicle or a condition of the climate which the vehicle is in.

Variation 10 may include a product as set forth in any of Variations 1-9 wherein the product comprises a vehicle and further comprising a controller constructed and arranged to cause the actuator to move in response to input from at least one of a vehicle speed sensor, engine compartment temperature sensor, radiator coolant temperature, turbocharger temperature, air mass intake sensor, rain sensor, snow/ice sensor, operator switch or ignition switch.

Variation 11 may include a product as set forth in any of Variations 1-10 further comprising a vehicle body panel, and wherein the plurality of louvers are constructed and arranged to be flush with an upper surface vehicle body panel when the louvers are in a closed position.

Variation 12 may include a product as set forth in any of Variations 1-11 wherein the vehicle body panel is an engine compartment hood.

Variation 13 may include a product as set forth in any of Variations 1-12 wherein the vehicle body panel is a fender.

Variation 14 may include a product as set forth in any of Variations 1-13 further comprising a vehicle body panel, and wherein the plurality of louvers are pivotally connected to the vehicle body panel.

Variation 15 may include a product as set forth in any of Variations 1-14 further comprising a vehicle component, and wherein the plurality of louvers are pivotally connected to the vehicle component.

Variation 16 may include a product comprising: an active hood extractor including a plurality of louvers, the plurality of louvers being constructed and arranged for sealing engagement with another vehicle component when the plurality of louvers are in a closed position.

Variation 17 may include a product as set forth in Variation 16 further comprising a hood extractor trim component, and wherein the plurality of louvers are each pivotally connected to the hood extractor trim component.

Variation 18 may include a product as set forth in any of Variations 16-17 further comprising a vehicle body panel, and wherein the plurality of louvers are each pivotally connected to the vehicle body panel.

The above description of select examples of the invention is merely exemplary in nature and, thus, variations or variants thereof are not to be regarded as a departure from the spirit and scope of the invention.

1. A product comprising:
an active hood extractor including a plurality of louvers, and actuator operatively connected to at least one louver, the plurality of louvers being constructed and arranged for sealing engagement with another vehicle component when the plurality of louvers are in a closed position.

2. A product as set forth in claim 1 wherein the active hood extractor includes a hood extractor trim component, and wherein the plurality of louvers are pivotally connected to the hood extractor trim component.

3. A product as set forth in claim 2 wherein the plurality of louvers are constructed and arranged to be flush with an upper surface of the hood extractor trim component when the louvers are in a closed position.

4. A product as set forth in claim 1 further comprising a tether connecting adjacent louvers.

5. A product as set forth in claim 1 wherein the louvers are connected together and so that movement of the actuator moves the plurality of louvers.

6. A product as set forth in claim 1 further comprising a compressible material on at least one of adjacent louvers to provide a seal when the adjacent louvers are in a closed position.

7. A product as set forth in claim 2 further comprising a compressible material on at least one of the plurality of louvers or the hood extractor trim component to provide a seal when the plurality of louvers are in a closed position.

8. A product as set forth in claim 1 further comprising a vehicle body panel, and a compressible material on at least one of one of the plurality of louvers or the vehicle body panel to provide a seal when the plurality of louvers are in a closed position.

9. A product as set forth in claim 1 wherein the product comprises a vehicle and further comprising a controller constructed and arranged to cause the actuator to move in response to input regarding an operating condition of the vehicle or a condition of the climate which the vehicle is in.

10. A product as set forth in claim 1 wherein the product comprises a vehicle and further comprising a controller constructed and arranged to cause the actuator to move in response to input from at least one of a vehicle speed sensor, engine compartment temperature sensor, radiator coolant temperature, turbocharger temperature, air mass intake sensor, rain sensor, snow/ice sensor, operator switch or ignition switch.

11. A product as set forth in claim 1 further comprising a vehicle body panel, and wherein the plurality of louvers are constructed and arranged to be flush with an upper surface vehicle body panel when the louvers are in a closed position.

12. A product as set forth in claim 11 wherein the vehicle body panel is an engine compartment hood.

13. A product as set forth in clam 11 wherein the vehicle body panel is a fender.

14. A product as set forth in claim 1 further comprising a vehicle body panel, and wherein the plurality of louvers are pivotally connected to the vehicle body panel.

15. A product as set forth in claim 1 further comprising a vehicle component, and wherein the plurality of louvers are pivotally connected to the vehicle component.

16. A product comprising:
an active hood extractor including a plurality of louvers, the plurality of louvers being constructed and arranged for sealing engagement with another vehicle component when the plurality of louvers are in a closed position.

17. A product as set forth in claim 16 further comprising a hood extractor trim component, and wherein the plurality of louvers are each pivotally connected to the hood extractor trim component.

18. A product as set forth in claim 16 further comprising a vehicle body panel, and wherein the plurality of louvers are each pivotally connected to the vehicle body panel.
